(19) United States
(12) Patent Application Publication
(10) Pub. No.: US 2011/0076497 A1
(43) Pub. Date: Mar. 31, 2011

(54) COATED CARBON NANOTUBES AND METHOD FOR THEIR PREPARATION

(75) Inventors: KIRK JEREMY ZIEGLER, Gainesville, FL (US); Wei-Chiang Chen, Baltimore, MD (US); Kai-Wei Wang, Canton, MI (US)

(73) Assignee: UNIVERSITY OF FLORIDA RESEARCH FOUNDATION, INC., GAINESVILLE, FL (US)

(21) Appl. No.: 12/891,300

(22) Filed: Sep. 27, 2010

Related U.S. Application Data
(60) Provisional application No. 61/245,920, filed on Sep. 25, 2009.

(51) Int. Cl. B32B 1/08; B82Y 30/00

(52) U.S. Cl. 428/375; 977/742; 977/750; 977/752

(57) ABSTRACT

Polymer coated carbon nanotube (NT) particles having NT particles with a solid polymer layer around the surface of each NT particle are presented. The NT particles can be isolated NTs or can include bundles of NTs. A method for preparation of the polymer coated carbon NT particles involves an aqueous dispersion that has a water insoluble first monomer contained in an emulsion-like nano-environment about the NT particles that undergoes an interfacial polymerization with a water soluble second monomer added to the dispersion.

### CROSS-REFERENCE TO RELATED APPLICATION

The present application claims the benefit of U.S. Provisional Application Ser. No. 61/245,920, filed Sep. 25, 2009, which is hereby incorporated by reference herein in its entirety, including any figures, tables, or drawings.

### BACKGROUND OF THE INVENTION

Single-walled carbon nanotubes (SWNTs) have received considerable attention due to there unparalleled combination of electrical, optical, and mechanical properties, as well as their chemical inertness. However, integrating individual SWNTs into applications is problematic due to the propensity of the nanotubes to assemble into bundles. It is therefore advantageous to have adequate dispersion of the SWNTs. Maintaining a dispersion of SWNTs without compromising the intrinsic properties of the nanotubes is challenging. Common solvents do not offer sufficient solvation forces to suspend SWNTs and typically yield very low degrees of solubility.

Much work has focused on the functionalization of SWNTs to effect dispersion. Functionalization leads to several disadvantages which can include: (1) the destruction of electrical, optical, and mechanical properties; (2) the production of large portions of small bundles rather than individually dispersed SWNTs; and (3) the involvement of significantly complicated processing. Other approaches to enhance dispersion of SWNTs involve the use of surfactants to stabilize SWNT suspensions.

The anionic surfactants sodium dodecyl sulfate (SDS) and sodium dodecylbenzene sulfonate (SDBS) are frequently used because of the high dispersion quality and near-infrared fluorescence properties. Duque et al. J. Am. Chem. Soc. 2008, 130, 2626-33 discloses the use of a surfactant surrounding SWNTs to create polymer-surfactant complexes that maintained the fluorescent properties of SWNTs even in acidic environments. Use of surfactants can preserve intrinsic properties of SWNTs (structure, conductivity), but at the expense of sensitivity to extrinsic factors, such as state of aggregation, polarizability of the surrounding environment, pH of the suspension, sidewall defects, and surfactant in homogeneities. Furthermore, while aqueous surfactant-SWNT systems show good dispersability in aqueous phases without affecting individual nanotube properties, such systems are poorly dispersible in a polymer phase. Encapsulation of SWNTs has been investigated. For example, Kim et al. Adv. Mater. 2007, 19 (7), 929-33 discloses the surfactant encapsulation of SWNTs by using surfactants with polymerizable counterions and a free radical initiator. Polymer coated isolated SWNTs that are not a surfactant coating would be useful for applications where dispersed or dispersible SWNTs are attractive.

### BRIEF SUMMARY OF THE INVENTION

Embodiments of the invention are directed toward polymer coated carbon nanotube (NT) particles where NT particles are coated with a solid polymer layer around the surface of each NT particles. The NTs can be individual isolated NTs or can be bundles of nanotubes where the polymer coating covers the entire bundle. The NTs can be single-walled carbon nanotubes (SWNTs), double-walled carbon nanotubes (DWNTs), multi-walled carbon nanotubes (MWNTs), or any combination thereof. In other embodiments of the invention traditional NTs are replaced or added to by functional equivalents such as graphene nanoplatelets or fullerenes. The polymer coating can be a polyamide, polyurea, polyurethane, polysulfonamide, polyester, polycarbonate, polyaniline, polyindole, polyporphorine ester, polychloroprene, polyethylene, polythiophene, polypyrrole, polyaniline or any other polymer capable of being polymerized by any interfacial method. The polymer can be cross-linked. The polymer coating can be primarily around a plurality of single isolated NT particle or can bridge between coated NT particles to form a matrix held together by the continuous polymer coating. The polymer coating can be continuous over the entire surface of each NT particle and can have a thickness that can range from 0.5 to 20 nm.

Other embodiments of the invention are directed to methods of preparing the polymer coated NT particles disclosed above, where a surfactant-NT particle dispersion, having NTs suspended by a surfactant in an aqueous solution, is mixed with a non-aqueous solution of a water insoluble first monomer and a non-aqueous solvent to form an emulsion-like nano-environment about the dispersed NTs, followed by the addition of a water soluble second monomer that results in polymerization of the first and second monomers at the interface of the aqueous solution and the emulsion-like nano-environment to form a polymer coating on the NT particles. Among surfactants that can be used are sodium dodecyl benzene sulfonate (SDBS), sodium dodecyl sulfate (SDS), or gum arabic (GA). The surfactant-NT particle dispersion can be at a concentration below the percolation threshold of the NT particles, to produce individually coated NT particles, or at a NT particle concentration above the percolation threshold, to produced polymer coated NT particles that contain polymer bridging between particles in the form of a matrix. The method can be extended to the removal of the non-aqueous solvent, water and/or the surfactant, as desired, using methods such as freeze drying, filtration, washing and extraction.

### BRIEF DESCRIPTION OF THE DRAWINGS

FIG. 1 is a conceptual drawing for coating individual SWNTs with nylon via a nano-environment around the SWNT containing a diacid chloride that will react at the interface of the nano-environment with an organic diamine from the aqueous solution.

FIG. 2 shows (a) a Fluorescence spectra (Ex.=662 nm) of the initial SDBS-SWNTs (1) and SDBS-SWNTs mixed with carbon tetrachloride (2) or carbon tetrachloride containing sebacoyl chloride (3). (b) Fluorescence spectra (Ex.=662 nm) of SWNTs before (3) and after (4) 5 min of polymerization compared to the initial SDBS-SWNT suspension (1).

FIG. 3 shows as scanned (a) and (b) background-corrected absorbance spectra of SDBS-SWNTs (1), SDBS-coated SWNTs mixed with carbon tetrachloride containing sebacoyl chloride (2), and nylon-coated SWNTs (3).

FIG. 4 shows normalized Raman spectra of the (a) SWNT suspension and (b) solid SWNT powder before and after polymerization where the inset shows the SWNT RBMs of each sample.

FIG. 5 shows FTIR spectra of SWNTs as received and after the nylon-coating process.

FIG. 6 shows AFM images and the corresponding histograms of the diameter distribution for (a) SDBS-SWNT and (b) nylon-coated SWNT suspensions.

FIG. 7 is a plot of the fluorescence intensity at various pH for (a) (7,6) SWNT (Ex.=662 nm), (b) (10,5) SWNT (Ex.=784 nm), and (c) (8,3) SWNT (Ex.=784 nm) types in SDBS-SWNT and nylon-coated SWNT suspensions.

FIG. 8 shows a photographic reproduction of nylon-coated SWNTs after (a) isolation by freeze-drying and (b) subsequent redispersion in water where (c) is the fluorescence spectra (Ex.=662 nm) for nylon-coated SWNT before (1) and after (2) freeze-drying compared to SDBS-SWNTs redispersed in water after freeze-drying (3).

### DETAILED DESCRIPTION OF THE INVENTION

Embodiments of the invention are directed to carbon nanotube (NT) particles that have been coated with a polymer where the coating follows the surface, generally the entire surface, of each NT particle with a continuous coating that does not display broad fluctuations of the coating topography but is regularly coated. Although the NT particles can be individual NTs that have been isolated from NT bundles, NT bundles or combinations thereof can be used in embodiments of the invention and the isolation of individual NTs can be carried out as needed for the requirements of a use or system employing the coated NT nanoparticles. In general, the NT particles that can form as an aqueous dispersion retain nearly the same degree of autonomy after being coated with the polymer, with the polymer bridging few of the NT particles that are separate within the dispersion. The extent of bridging by the polymer coating between coated NT particles can be almost nil when the coated NT particles are prepared from a sufficiently dilute suspension according to embodiments of the invention. In general the NT suspensions for preparation of the individually coated NT particles have NTs at a concentration well below the percolation threshold of the NTs in the suspension medium, although the ultimate uses or system to which the NTs are employed defines the degree to which bridging is avoided or encouraged. In some applications of the invention the concentration of NT particles in the suspension can be at or above the percolation threshold to form a system where bridging of the NT particles by the polymer coating is encouraged and a matrix of coated nanotubes can be formed. In this manner, properties that result from the interaction of NTs in addition to properties displayed by individual NTs can be achieved by the coated nanotube matrix. The percolation threshold will depend on the length of the NTs and the NT particles. The thickness of the polymer coating can range from 0.5 to 20 nm where the thickness can be controlled by the choice of solvent, monomer concentration, and control over the polymerization equilibrium by factors that include, for example the pH.

The NTs can be single-walled (SWNTs), double-walled (DWNTs), multi-walled (MWNTs) or any mixture thereof. In some embodiments of the invention the NT particles can be functional equivalents to NTs that can be used in addition to or in place of the NTs. Functional equivalents to NTs are any nanoparticle with a graphene surface, including graphene nanoplatelets and fullerenes. Exemplary embodiments of the invention are directed to SWNTs, but it should be understood that any other NTs or functional equivalents can be used depending upon the requirements of the applications or systems where the coated NT particles are ultimately to be used.

According to embodiments of the invention, polymer coatings on the NT particles can be any polymer that can be formed by an interfacial polymerization. Exemplary embodiments of the invention are directed to polyamide coated NT particles, but other polymers can constitute the coating, including, but not limited to, polyureas, polyurethanes, polysulfonamides, polyesters, polycarbonates, polyanilines, polyindoles, polyporphorine esters, polychloroprene, polyethylene, polythiophene, polypyrrole, and polyaniline where appropriate monomer for preparing specific polymers will be understood by those skilled in the art. The polymers are not from polymerizable surfactants.

The polymer coating can be a homopolymer or a copolymer. By the use of tri- or multifunctional monomers within a monomer mixture used to form the polymer coating a network can be generated about the NT particle. By inclusion of a monofunctional monomer, the degree of polymerization can be controlled and where a combination of tri- or multifunctional monomers and monofunctional monomers a branched polymer coating can be formed. The structure of the polymer coating that is formed depends not only on the reactivity of the different monomers in the reactive phase, but also upon the relative partitioning of the monomers between the reactive phase in the vicinity of the NT and the continuous phase in the suspension. Because of differences in the partitioning of monomers, different compositions can be formed during the polymerization such that some monomers can be incorporated primarily during the initial polymerization and other monomers can be incorporated toward the end of the polymerization, which, in some embodiments, can result in a gradient of compositions about the NTs. For example, by use of trifunctional and difunctional water soluble monomers, lesser partitioning of the trifunctional to the nonaqueous can occur such that polymerization results in a gradient of cross-linking densities of the coating.

The method of making the polymer coating according to embodiments of the invention involves establishing a suspension of NT particles in an aqueous solution using a surfactant as the suspending agent, partitioning a solution of at least one water insoluble monomer in a non-aqueous solvent on the surface of the suspended NT particles to form an emulsion-like nano-environment around the NTs, and introducing at least one water soluble complementary monomer to the aqueous solution of the suspension, where the complementary monomers react at the interface between the aqueous and non-aqueous solutions to form a polymer coating on the NT particles. As required, the polymer coated NT particles can be isolated from the aqueous solution and residual organic solvents and surfactants can be removed.

The suspension of NT particles is achieved by mixing NTs with the aqueous surfactant solution. The mixing generally requires high sheer mixing and can be performed using any or a combination of a rotor/stator mixer, high-speed disperser, ultrasonic mixers, or any other dispersing apparatus. The surfactant can be any surfactant that is known for dispersing NTs, including but not limited to sodium dodecyl benzene sulfonate (SDBS), sodium dodecyl sulfate (SDS), and gum arabic (GA). Other surfactants that can disperse NTs are known and can be found in the literature, see, for example, Moore et al., Nano Lett., 2003, 3(10), 1379-82. The surfactant used will vary depending on the non-aqueous solvent and water insoluble monomer. The relative affinity of the surfactant for the NTs and non-aqueous solvent should be considered during selection of the surfactant and solvent.

The suspension of NT particles can be mixed with a solution of one or more first monomers in a non-aqueous solvent. Upon mixing a portion of the non-aqueous solution forms an emulsion-like nano-environment around the NT particles where the non-aqueous solution resides as a liquid sheath about the NT surface with the surfactant forming a stabilized interface between the liquid sheath and the aqueous solution in which the NT particles are suspended. Such emulsion-like nano-environment are disclosed in Wang et al., J. Am. Chem. Soc. 2008, 130, 1633-7, incorporated herein by reference, where mixing aqueous SWNT suspensions with immiscible organic solvents changes the environment around a dispersed SWNT. The nano-environment can have a variety of thicknesses and concentrations of the first monomers such that various polymer coating thicknesses can be formed on the NTs, depending upon the surfactant, its concentration, the non-aqueous solvent and the concentration of the first monomers. Excess non-aqueous solution can be separated from the aqueous suspension. Separation consists of allowing phase separation of the bulk non-aqueous solution from the aqueous suspension and separating the separated phases by known techniques that generally remove one or the other phase, such as using a separatory funnel, centrifugal contactor, thin layer extractor, spray column, pulsed column, or mixer-settler. Those skilled in the art can appreciate the conditions and scale of the process where one separation technique would be preferred over another such that the desired aqueous suspension of the NT particles with the emulsion-like nano-environment can be employed for interfacial polymerization. The amount of non-aqueous solution introduced to the NT suspension can result in the emulsion-like nano-environment around the NT particles with little no excess bulk non-aqueous phase for separation. Some formation of nano- or micro-particulate polymer can occur in the dispersion that is free of the NT particles with little or no deleterious effect to the polymer coated NT particles, and in some instances can be beneficial.

The first monomer that is in the emulsion-like nano-environment has a plurality of highly reactive functionality that is capable of undergoing a rapid reaction with at least one complementary water soluble second monomer that has a plurality of a reactive functionality that can add to or condense with the highly reactive functionality of the first monomer in the emulsion-like nano-environment on contact of the second monomer with the nano-environment. Although in many of the systems the first monomer is capable of reacting with water, the low miscibility of the first monomer in water and the very low solubility of water in the non-aqueous solvent sufficiently inhibit hydrolysis of the first monomer during the time period over which the partitioning of the non-aqueous first monomer solution to the nanotube surface, separation of excess bulk when needed, and polymerization with the second monomer occurs.

The non-aqueous solvent can be any solvent sufficiently insoluble with water but can dissolve the first monomer. In embodiments of the invention the non-aqueous solvent does not dissolve the surfactant. In some embodiments of the invention, the solvent is volatile, having a low boiling point, for example below 100° C. Solvents that can be used, according to embodiments of the invention include, but are not limited to: chlorinated hydrocarbons, such as carbon tetrachloride and chloroform; ethers, such as diethylether and dibutylether; hydrocarbons, such as heptane and cyclohexane; aromatic hydrocarbons, such as benzene, toluene, and p-xylene; or other water insoluble organic solvents.

The second monomer is introduced to the aqueous solution in a manner such that it rapidly dissolves into the aqueous solution from which it diffuses into the emulsion-like nano-environment, reacting with the first monomer or the reactive ends of the growing polymer chain. Because the polymerization reaction is rapid, the polymer chain is formed in non-aqueous phase in the vicinity of the interface between the nano-environment and the aqueous solution such that the majority of the reaction is between the growing polymer and a monomer diffusing to the polymer. The second monomer can be introduced rapidly or over a period of time. The polymerization system can be static or agitated in a manner that the interface of the growing polymer coating and the aqueous solution can be maintained.

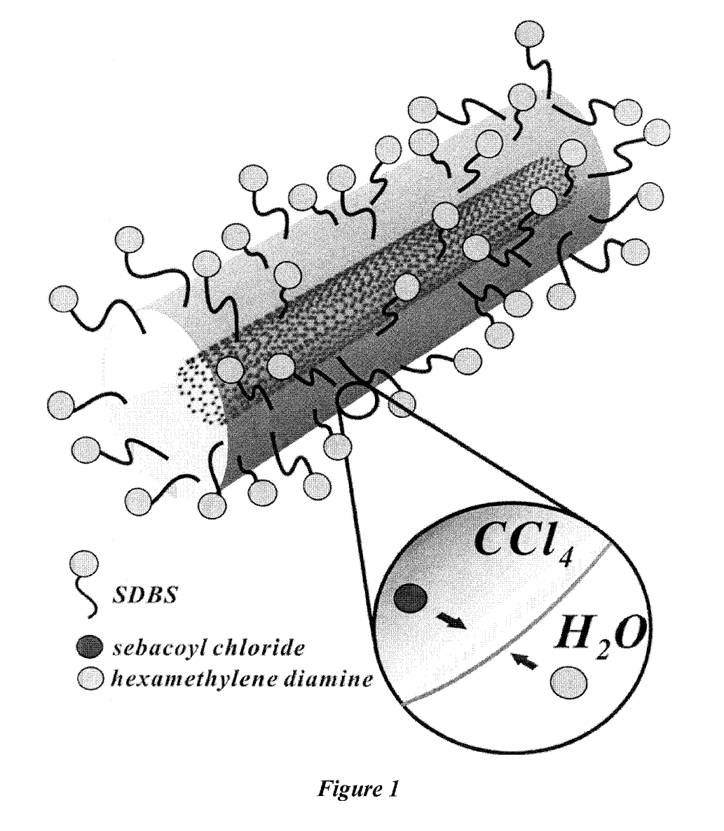

The novel method is exemplified in an embodiment of the invention where nylon-6,10, a polyamide, is formed around individual SWNTs. The reaction equation for the preparation of nylon 6,10 is shown in Scheme 1, below. In this embodiment of the invention, the first monomer is a 10 carbon chain diacid chloride, sebacoyl chloride, that is dissolved in the solvent carbon tetrachloride. The carbon tetrachloride solution is mixed with a suspension of SWNTs using SDBS as the surfactant (SDBS-SWNT) to form the emulsion-like nano-environment around the SWNTs. FIG. 1 is a conceptual drawing of a portion of the emulsion-like nano-environment around a SWNT. The second monomer is a 6 carbon organic diamine, hexamethylene diamine. The diamine is added to the aqueous suspension and polymerization occurs spontaneously at the interface of the emulsion-like nano-environment around the nanotube to form a thin polymer-coating of nylon 6,10 around the SWNT.

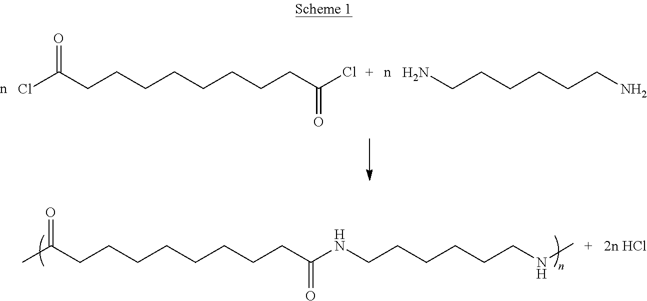

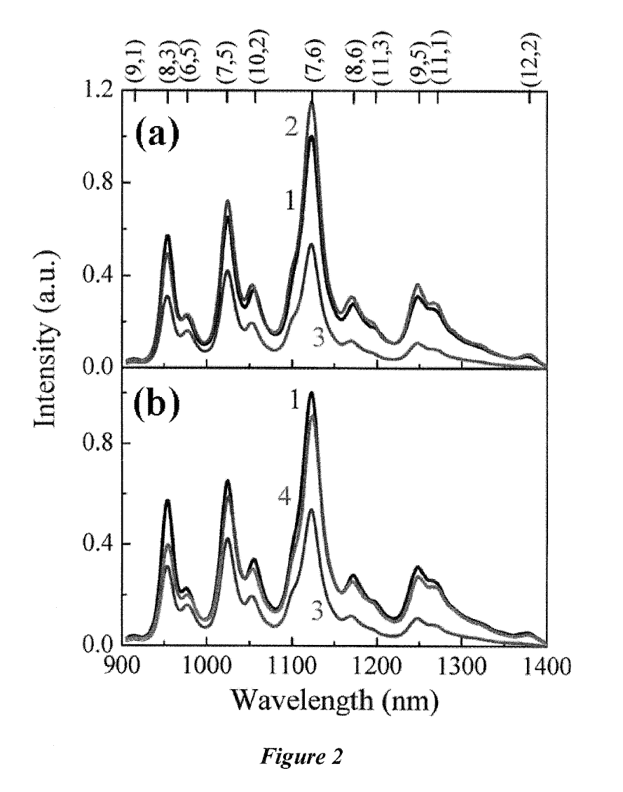

The formation of the emulsion-like nano-environment around the SWNTs surface is evident from fluorescence spectra. As shown in FIG. 2a, the fluorescence spectral changes are characteristic of a SDBS-SWNT suspension. The fluorescence emission of SDBS-suspensions displays a slight blue-shift with an increase in intensity when mixed with pure carbon tetrachloride. The blue-shift represents a change to a less polar environment, whereas the intensity increase is potentially due to either a solvent effect or reorganization of the surfactant in a manner that minimizes quenching. Upon mixing SDBS-SWNT suspensions with 0.5 M sebacoyl chloride in carbon tetrachloride, a significant decrease results in the fluorescence intensity relative to that observed for the initial suspension or the solvent-swelled states. The peak positions are the same with or without sebacoyl chloride added, which suggests the nano-environment around the NTs is similar (i.e., carbon tetrachloride). Therefore, the intensity decrease is associated with the presence of the sebacoyl chloride within the emulsion-like phase surrounding the SWNT. Hence, the spectral changes confirm the presence of sebacoyl chloride surrounding the SWNTs.

Upon addition of the hexamethylene diamine a significant increase in fluorescence intensity is observed, as shown in FIG. 2b. The intensity recovers to values that are nearly identical to those of the initial SDBS-SWNT suspension rather than the spectra for SWNTs encased in a carbon tetrachloride shell. These differences are likely due to pH changes caused from HCl generation upon reaction. The spectra show a red-shift, indicating that the environment surrounding the nanotube has been altered. The change of the spectral properties is consistent with consumption of the sebacoyl chloride by reaction with the hexamethylene diamine at the interface.

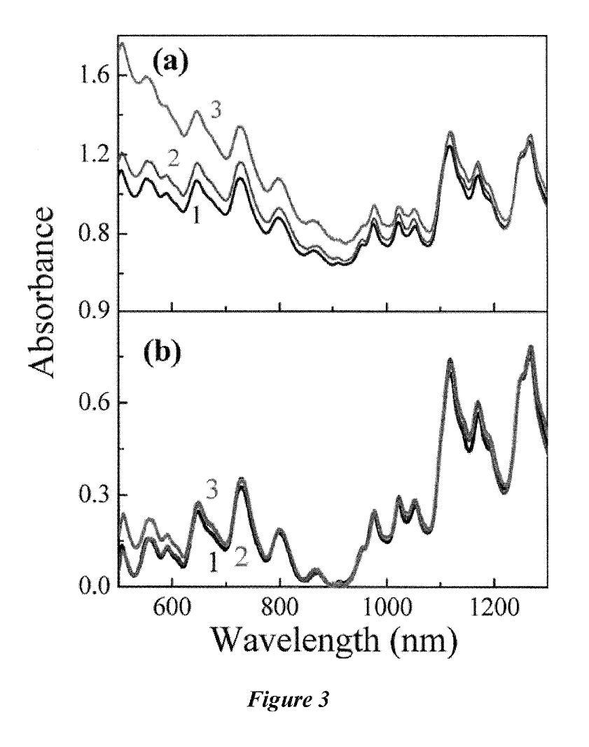

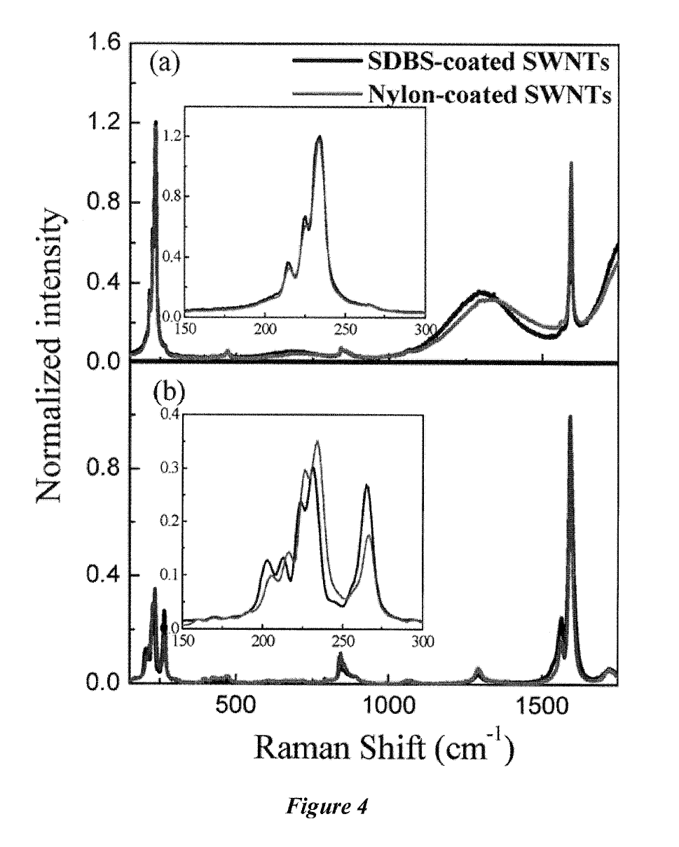

Absorbance spectra, as shown in FIG. 3, and Raman spectra, as shown in FIG. 4, indicate that aggregation of the SWNTs does not occur. FIG. 3a shows the absorbance spectra of each SWNT suspension. The spectra have well-resolved peaks associated with interband transitions of SWNTs. After the SWNT suspension is mixed with sebacoyl chloride, there is a slight red-shift and an increase in visible absorbance (400-900 nm). The nylon-coated SWNTs display well resolved peaks in the NIR region (900-1400 nm) but show a further increase in visible absorbance. The higher absorbance background for the monomer- and polymer-coated SWNT suspensions seen in the visible light region is likely due to scattering from emulsions and polymer particles. After removing the effect of the background, which is shown in FIG. 3b, the trend and intensity of the absorbance spectra are similar at each stage of the polymerization reaction.

The distinguishable and intense peaks in the NIR region indicate that SWNTs are individually suspended throughout the reaction. This conclusion is also supported by both liquid phase and solid-state Raman spectra, as shown in FIG. 4. The SWNT radial breathing modes (RBMs) of the liquid-phase Raman spectra, shown in the inset of FIG. 4a, display no changes after polymerization to the so-called aggregation peak located at ˜270 cm⁻¹. The solid-state Raman spectra, shown in FIG. 4b, display an upshift of approximately 2-3 cm⁻¹ in the RBMs. The upshifts are consistent with those observed for SWNTs embedded in polymer matrices. Buisson et al., Mater. Res. Soc. Symp. Proc. 2001, 633, A14.12.1. discloses a model to relate the shift in the RBMs to the structure of the polymer around the SWNTs. That model suggests that polymer coatings around SWNT bundles should show a more significant upshift of the RBMs than individually coated SWNTs. The model predicts that a nylon coating would result in a 41 cm⁻¹ for bundled SWNTs and of 13 cm⁻¹ for individual SWNTs. The observed upshift in the RBMs, shown in FIG. 4b, is less than either value, which, in addition to the low magnitude of the shift, suggests that nylon coats individual rather than bundled SWNTs.

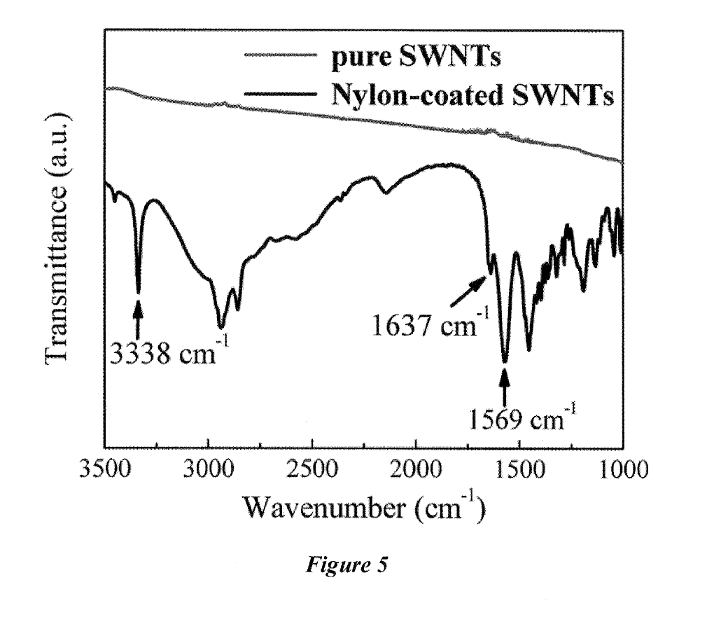

Pure nylon 6,10 synthesized via interfacial polymerization is a white powder with characteristic FT-IR stretches of the amide-I peak at 1640 cm⁻¹, the amide-II peak at 1545 cm⁻¹, the C-H stretch at 2860 and 2940 cm⁻¹, and the N-H stretch at 3330 cm⁻¹. FIG. 5 shows the FT-IR spectra of SWNTs and polymer-coated SWNTs. The polymer-coated SWNTs show amide-I, amide-II, and N-H stretching groups at 1637, 1569, and 3338 cm⁻¹, respectively, indicating that nylon 6,10 coats the SWNTs.

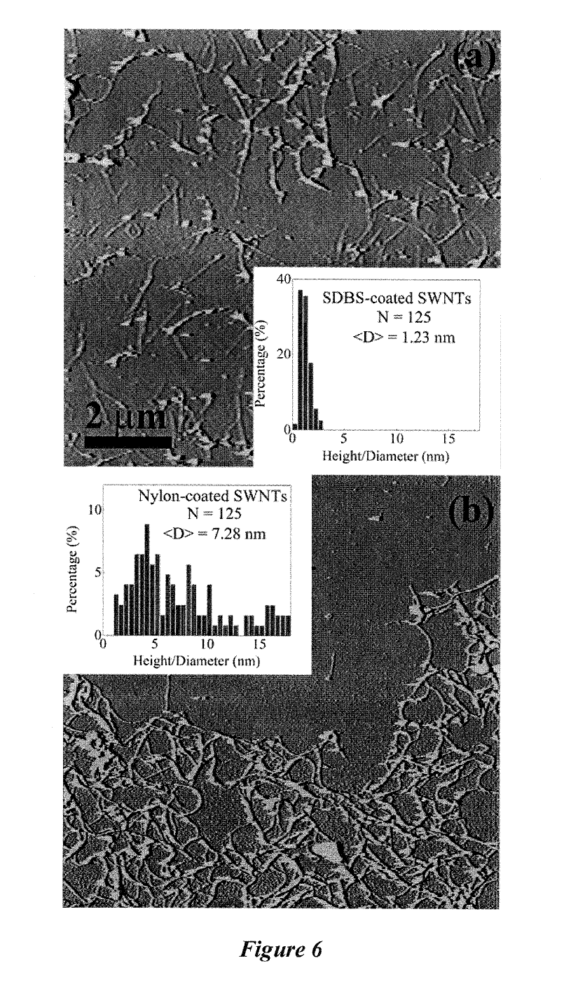

An AFM image of individual SWNTs suspended in SDBS is shown in FIG. 6a. The inset of FIG. 6a shows the diameter distribution is narrow with an average diameter of 1.2 nm. FIG. 6b shows the nanotubes after the nylon 6,10 polymerization reaction. Individual SWNTs are still observed after the polymerization reaction; however, it is clear that the surface morphology has changed around the nanotube. After the polymerization reaction, the diameter distribution for nylon-coated SWNTs, shown in the inset of FIG. 6b, becomes broader with an average diameter of 7.3 nm. The diameter distribution of the polymer-coated SWNTs suggests that the coating thickness ranges between 0.5 and 8 nm with an average thickness of 3 nm.

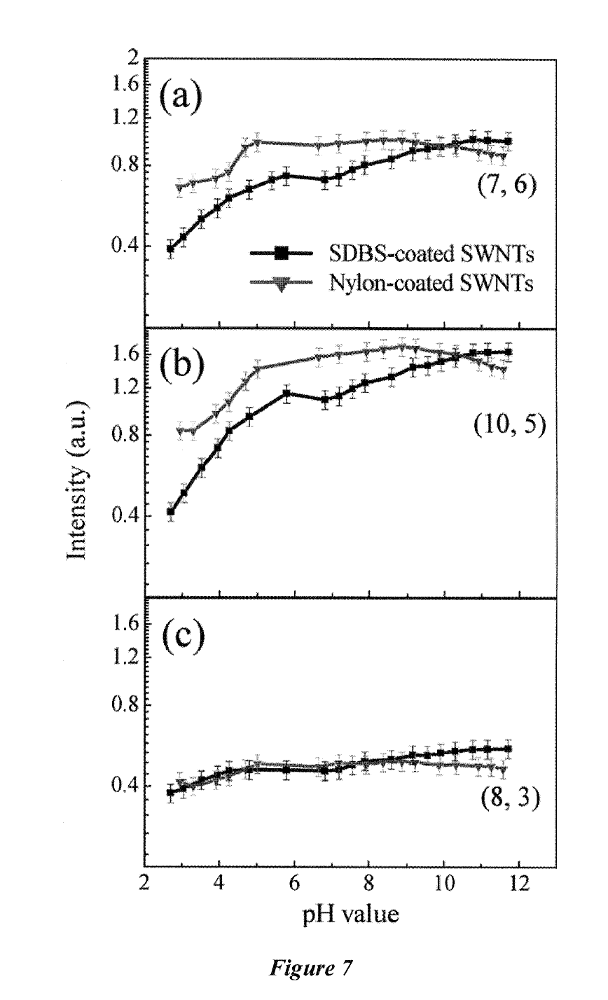

The thin coating of nylon encapsulating SWNTs affords better protection to the fluorescence quenching effects of acids as indicated in the high fluorescence intensity shown in FIG. 2b despite the acidic pH generated during polymerization. FIG. 7 shows the effect of pH on the fluorescence intensity of different (n,m) SWNT types. The fluorescence intensity of all SWNT types in the initial suspension of SDBS-SWNTs steadily decrease as the pH is lowered from basic to acidic conditions. In contrast, the fluorescence intensity of nylon-coated SWNTs is higher and more stable than the fluorescence of SDBS-SWNTs, especially for large diameter SWNTs. For example: the (10,5) SWNT type typically has an emission intensity that is 50-100% higher than the SDBS-SWNTs at acidic pH; the (7,6) SWNT type also has significant improvement across the acidic pH region; whereas the (8,3) SWNT type has little improvement to the emission intensity. The lack of any changes for the (8,3) SWNT type likely indicates that the initial surfactant structure provides a nearly ideal protective layer to pH quenching, minimizing any benefit achieved by adding a nylon coating.

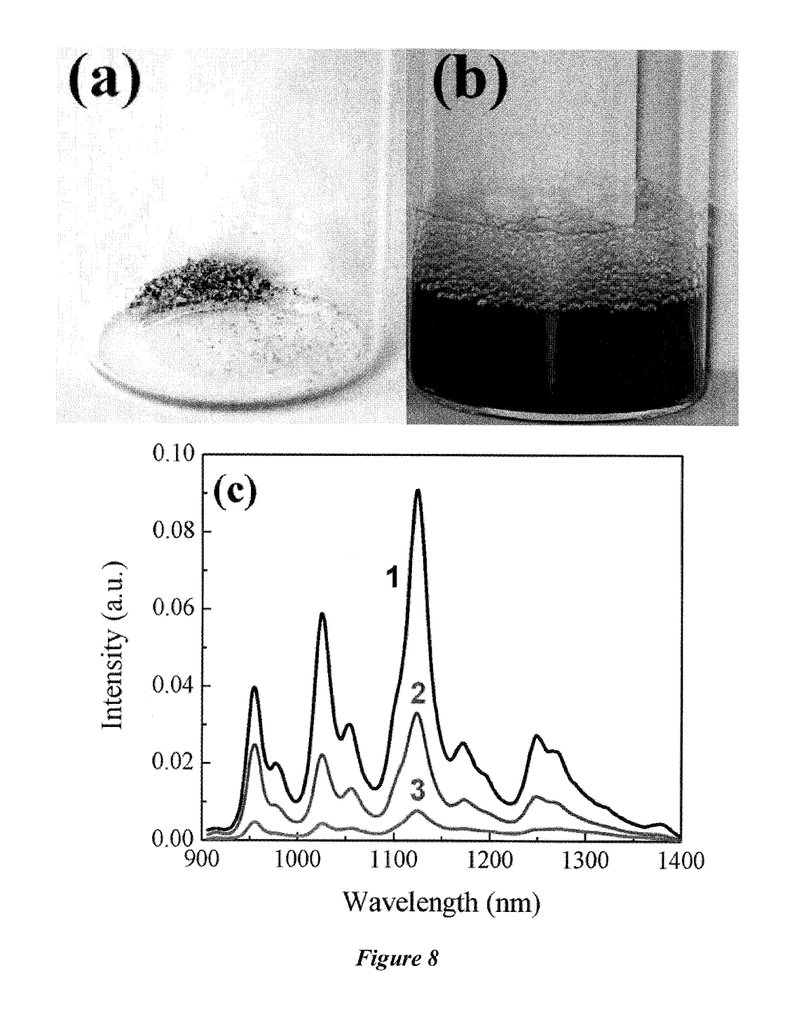

The nylon coating around SWNTs allows relatively easy redispersion of the nanotubes in water. FIGS. 8a and 8b are photographic images of nylon-coated SWNTs after being freeze-dried and their subsequent resuspension, respectively. Nylon-coated SWNTs are readily redispersed in water without any visible aggregation where their fluorescence spectrum, as shown in FIG. 8c, displays well-resolved peaks. The fluorescence intensity of redispersed nylon-coated SWNTs is less than half the intensity of the nylon-coated SWNTs before freeze drying; however, the nylon-coated SWNTs display a four times higher fluorescence intensity than that from freeze-dried SDBS-SWNTs.

The nylon coating surrounding the nanotubes does not affect the optical properties of the SWNTs. The solid state Raman spectra shown in FIG. 4b displays no changes after polymerization to the D-band (˜1290 cm⁻¹) associated with covalent bonding to a carbon nanotube sidewall. These results are in agreement with the intense fluorescence spectra seen in FIG. 2b, which is very sensitive to sidewall reactions. Therefore, the polymer coating appears to be physisorbed onto the SWNT sidewall, allowing the structure and properties of SWNTs to be preserved.

### Materials and Methods

### Preparation of Aqueous SWNT Suspensions

Aqueous SWNT suspensions were prepared by mixing 40 mg of SWNTs (Rice HPR 122.1) with 200 mL of an aqueous solution (1 wt %) of sodium dodecyl benzene sulfonate (SDBS) (Sigma-Aldrich). High-shear homogenization (IKA T-25 Ultra-Turrax) at 12 000 rpm for 2 hours and ultrasonication (Misonix S3000) with 90% amplitude for 10 minutes were used to aid dispersion. After ultrasonication, the SWNT suspension was ultracentrifuged at 20 000 rpm (Beckman Coulter Optima L-90 K) for 3 hours to remove nanotube bundles. An estimated final concentration of SWNTs was 20 mg/L.

### Interfacial Polymerization by Swelling Surfactant Micelles

A 0.5 M sebacoyl chloride (Sigma-Aldrich, 98%) solution in carbon tetrachloride (Sigma-Aldrich, 99%) was prepared. A 5 mL portion of the aqueous SDBS-SWNT suspension was added slowly to 5 mL of the sebacoyl chloride solution. The resulting mixture was shaken vigorously with a Vortex stirrer at 2000 rpm for 30 seconds to form organic-swelled nano-environments around SWNTs. The aqueous organic-swelled SWNT suspension was carefully removed from the bulk carbon tetrachloride after phase separation after 1 hour using a glass pipet to prevent shearing and any further emulsification. Hexamethylene diamine (Sigma-Aldrich, 97%) was liquefied at 50° C. and 0.002 mL of the liquid hexamethylene diamine was injected into the solvent-swelled aqueous SWNT suspension. After hexamethylene diamine injection into the aqueous SWNT suspension, the black SWNT suspension changed gradually from black to blue-gray during formation of the nylon coating about the SWNTs.

### Resuspension

Dry powder samples of SDBS-SWNTs and the polymer-coated SWNTs of above were obtained by freeze-drying (LABCONCO Freeze-Dryer 8). The individual SWNTs samples were redispersed by adding 5 mL of DI water to each powder sample and tip sonicating (Misonix. 53000) with 10% amplitude for 1 minute.

### Characterization

NIR-fluorescence and vis-NIR absorbance spectra of all aqueous SWNT suspensions were characterized with an Applied NanoFluorescence Nanospectrolyzer (Houston, Tex.) with excitation from 662 and 784 nm diode lasers. Raman spectra of the aqueous SWNT suspensions and the solid powders of SWNTs before and after polymerization were recorded using a Renishaw Invia Bio Raman with a 785 nm diode laser source. All Raman spectra were normalized to the G-band (˜1590 cm⁻¹). The SDBS-SWNT and polymer-coated SWNT suspensions were also spin-coated onto fresh mica to acquire tapping-mode AFM images on a Digital Instruments Dimension 3100. The diameters of SDBS-coated and nylon-coated SWNTs were measured from 10 AFM images of each sample with the NanoScope v5.30r1 software. At least 125 SWNTs were measured for each sample to generate histograms.

The surfactant was removed for FT-IR analysis by adding 5 mL of ethyl acetate to the polymer-coated SWNT suspension. The mixture was then shaken with a Vortex stirrer at 2000 rpm for 30 seconds to remove the SDBS surfactant. After phase separation, bulk ethyl acetate solution was removed and the polymer coated SWNT suspension was freeze-dried to yield a dry gray powder of polymer-coated SWNTs. The chemical structure of the polymer-coated SWNTs was analyzed by FT-IR spectroscopy (Nicolet MAGNA 760 FTIR).

All patents, patent applications, provisional applications, and publications referred to or cited herein, supra or infra, are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. Polymer coated carbon nanotube (NT) particles comprising;
a plurality of NT particles; and
a solid polymer layer around the surface of each of said plurality of NT particles.

2. The polymer coated NT particles of claim 1, wherein said NTs are single-walled carbon nanotubes (SWNTs), double-walled carbon nanotubes (DWNTs), multi-walled carbon nanotubes (MWNTs), or a combination thereof.

3. The polymer coated NT particles of claim 1, wherein said polymer comprises polyamide, polyurea, polyurethane, polysulfonamide, polyester, polycarbonate, polyaniline, polyindole, or polyporphorine ester.

4. The polymer coated NT particles of claim 1, wherein said polymer comprises polychloroprene, polyethylene, polythiophene, polypyrrole, or polyaniline.

5. The polymer coated NT particles of claim 1, wherein said NT particles comprise isolated NTs, bundled NTs, or a combination thereof.

6. The polymer coated NT particles of claim 1, wherein said NT particles comprise a NT functional equivalent comprising a graphene nanoplatelet or a fullerene.

7. The polymer coated NT particles of claim 1, wherein said NT particles are bridged by said polymer layer, wherein said polymer coated NT particles comprise a matrix.

8. The polymer coated NT particles of claim 1, wherein said solid polymer layer is cross-linked.

9. A method of preparing the polymer coated carbon nanotubes particles according to claim 1 comprising:
providing a surfactant-NT particle dispersion comprising NTs, a surfactant and an aqueous solution;
mixing a non-aqueous solution comprising a water insoluble first monomer and a non-aqueous solvent with said surfactant-NT particle dispersion, wherein a portion of said non-aqueous solution forms an emulsion-like nano-environment about each of said dispersed NTs; and
adding a water soluble second monomer, wherein said second monomer polymerizes with said first monomer at the interface of said aqueous solution and said emulsion-like nano-environment to form a dispersion of polymer coated carbon nanotubes particles.

10. The method of claim 9, wherein said surfactant comprises sodium dodecyl benzene sulfonate (SDBS), sodium dodecyl sulfate (SDS), or gum arabic (GA).

11. The method of claim 9, wherein said non-aqueous solvent comprises an organic solvent.

12. The method of claim 9, wherein said non-aqueous solvent comprises a halogenated solvent.

13. The method of claim 9, wherein said first monomer is a diacid chloride.

14. The method of claim 9, wherein said second monomer is an organic diamine.

15. The method of claim 9, wherein said surfactant-NT particle dispersion comprises said NTs at a concentration below a percolation threshold.

16. The method of claim 9, wherein said surfactant-NT particle dispersion comprises said NTs at a concentration above a percolation threshold.

17. The method of claim 9, further comprising removal of said non-aqueous solvent.

18. The method of claim 9, further comprising removal of water.

19. The method of claim 18, further comprising removal of said surfactant.
